(19) United States
(12) Patent Application Publication
(10) Pub. No.: US 2005/0221266 A1
(43) Pub. Date: Oct. 6, 2005

(54) System and method for assessment design

(76) Inventors: Robert J. Mislevy, Annapolis, MD (US); Geneva D. Haertel, Palo Alto, CA (US); Lawrence A. Hamel, Menlo Park, CA (US); Cathleen A. Kennedy, Belmont, CA (US); Mark Wilson, Kensington, CA (US)

Correspondence Address: MOSER, PATTERSON & SHERIDAN, LLP;SRI INTERNATIONAL, 595 SHREWSBURY AVENUE, SUITE 100, SHREWSBURY, NJ, 07702, US

(21) Appl. No.: 11/098,059

(22) Filed: Apr. 4, 2005

Related U.S. Application Data
(60) Provisional application No. 60/558,818, filed on Apr. 2, 2004.
(60) Provisional application No. 60/615,414, filed on Oct. 2, 2004.
(60) Provisional application No. 60/631,947, filed on Nov. 30, 2004.

(51) Int. Cl. G09B 7/00

(52) U.S. Cl. 434/322

(57) ABSTRACT

A method and apparatus are provided for designing educational assessments. In one embodiment, a method for guiding a user in the design of an assessment includes receiving, from the user, one or more goals relating to the assessment and translating those goals into a task specification for an assessment task in accordance with one or more user-defined variables.

### CROSS REFERENCE TO RELATED APPLICATIONS

This application claims the benefit of U.S. Provisional Patent Application Ser. Nos. 60/558,818, filed Apr. 2, 2004 (titled “System And Method For Evidence-Centered Design To Access Student Inquiry Skills”); 60/615,414, filed Oct. 2, 2004 (titled “Principled Assessment Design For Inquiry”); and 60/631,947, filed Nov. 29, 2004 (titled “Design Pattern For Assessing Science Inquiry”); all of which are herein incorporated by reference in their entireties.

### REFERENCE TO GOVERNMENT FUNDING

The invention was made with Government support under grant number REC-0129331 awarded by the National Science Foundation. The Government has certain rights in this invention.

### FIELD OF THE INVENTION

The present invention relates generally to educational assessment design and relates more specifically to systems for constructing evidence-centered educational assessment models.

### BACKGROUND OF THE DISCLOSURE

An educational assessment is a special kind of evidentiary argument that requires making sense of complex data to draw inferences or conclusions. Specifically, an educational assessment is a way of gathering information (e.g., in the form of particular things that students say, do or make under particular circumstances) to make inferences about what students know, can do, or have accomplished or learned.

FIG. 1 is a simplified flow diagram illustrating the principal phases of a typical process 100 for designing and administering an assessment. In the illustrated embodiment, the process 100 comprises five principal phases: domain analysis 102, product requirements 104, domain modeling 106, conceptual assessment framework 108 and assessment delivery 110. In the domain analysis phase 102, the knowledge and skills in the domain (subject area) to be assessed are identified and analyzed from a number of perspectives (e.g., cognitive research, available curricula, expert input, educational standards and current testing practices, etc.), in order to identify the concepts and relationships that can play roles in assessment arguments in the domain.

In the domain modeling phase 106, information from the domain analysis phase 102 is organized into assessment arguments (e.g., by specifying the relationships among the identified knowledge and skills). Assessment designers and other interested parties provide product requirements 104, including, for example, the knowledge or skills that the assessment is meant to measure. In the conceptual assessment framework phase 108, more technical elements of the assessment are laid out, such as psychometric models, scoring rubrics, descriptions of stimulus materials and administration conditions. In the assessment delivery phase 110, assessment tasks are selected and presented to students, student work products are gathered and evaluated, and inferences about student proficiencies are computed and reported.

Thus, the construction of a meaningful educational assessment, e.g., through the building of tasks and arguments that lead to the desired inferences, typically requires expertise across a variety of domains (e.g., subject matter domains and learning, assessment design, task authoring, psychometrics, etc.). As such, this task is especially challenging for the average education professional, or, in fact, for any single individual in general.

Thus, there is a need in the art for a system and method for assessment design.

### SUMMARY OF THE INVENTION

A method and apparatus are provided for designing educational assessments. In one embodiment, a method for guiding a user in the design of an assessment includes receiving, from the user, one or more goals relating to the assessment and translating those goals into a task specification for an assessment task in accordance with one or more user-defined variables.

### BRIEF DESCRIPTION OF THE DRAWINGS

The teachings of the present invention can be readily understood by considering the following detailed description in conjunction with the accompanying drawings, in which:

FIG. 1 is a simplified flow diagram illustrating the principal phases of a typical process for designing and administering an assessment;

FIG. 2 is a flow diagram illustrating one embodiment of a method for guiding a user in the construction of assessment task specifications, according to the present invention;

FIGS. 3A-3C comprise a graphical (tabular) representation of an exemplary design pattern according to the present invention;

FIG. 4 is an object model illustrating a generic design pattern and its related objects, according to the present invention;

FIG. 5 is a schematic diagram illustrating an exemplary task template according to the present invention;

FIG. 6 is a tabular representation of an exemplary task template according to the present invention;

FIG. 7 is an object model illustrating a generic task template and its related objects, according to the present invention; and

FIG. 8 is a high level block diagram of the present method for guiding a user in the construction of an assessment task specification that is implemented using a general purpose computing device.

To facilitate understanding, identical reference numerals have been used, where possible, to designate identical elements that are common to the figures.

### DETAILED DESCRIPTION

The present invention relates to a system and method for assessment design (e.g., for evaluating student learning). Specifically, embodiments of the invention facilitate the construction of meaningful educational assessments by guiding the thinking of a user (e.g., an individual building an assessment). This is especially significant where the user has limited prior experience in the field of assessment design. Although the present invention is described below within the exemplary context of science inquiry (e.g., the assessment of learning of inquiry skills in the science domain), those skilled in the art will appreciate that the present invention may be applied in the design of assessments for substantially any field of learning (e.g., literacy, history, etc.).

As used herein, the term “student” refers to an individual whose knowledge, skills and abilities in a particular domain or subject area are to be evaluated by an assessment designed according to the present invention; the term “educational assessment” refers to the means of evaluating the student's acquired knowledge, skills and abilities and may be embodied in a variety of different formats or contexts (e.g., including, but not limited to, classroom assessments, formative assessments, large-scale assessments, certifications, assessments of teaching, tutoring and embedded assessments); the term “assessment task” refers to a particular undertaking required by the educational assessment in order to provide evidence of the student's acquired knowledge, skills and abilities; the term “task specification” refers to a complete definition of an assessment task (e.g., such that the assessment task can be rendered and delivered to the student, student responses can be gathered and evaluated, and inferences can be drawn in compliance with an established measurement model, based on the task specification); the term “wizard” refers to an interactive, automated interview process that accepts input values from a user and acts accordingly in the development of the educational assessment; the term “user-defined variables” refers to any attribute of any object or model in the assessment design system according to the present invention; and the terms “rubric” and “evaluation procedure” refer to any technique for evaluating a student's work product (e.g., by assigning a numerical score).

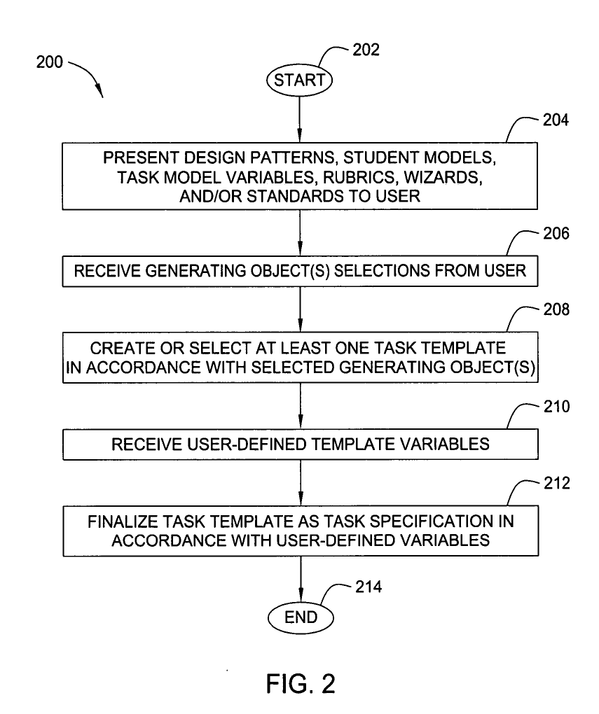

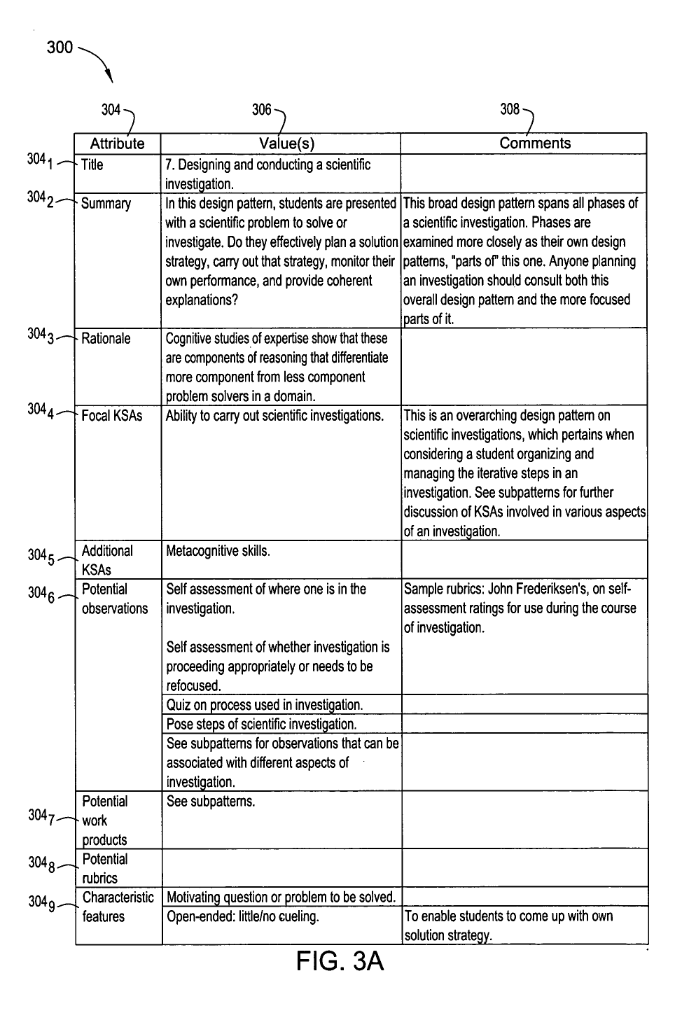

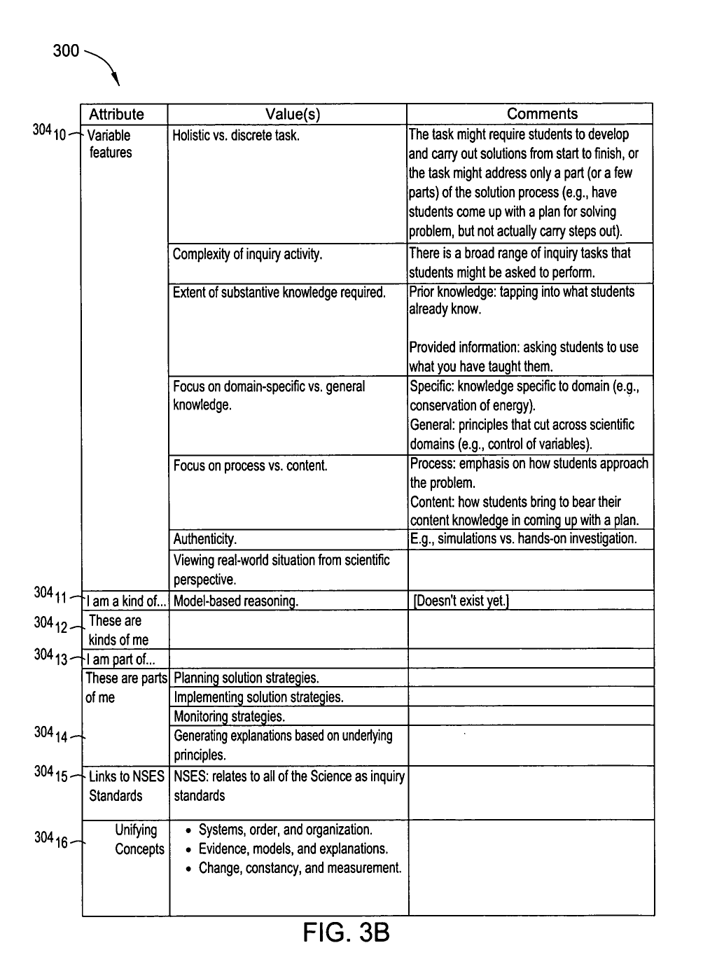

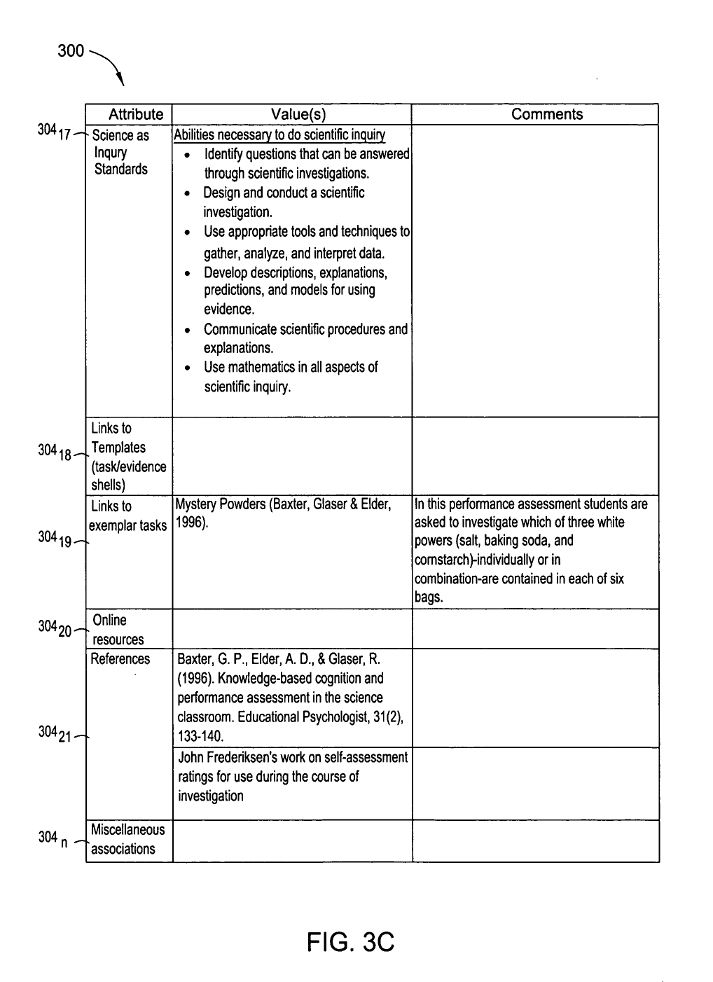

FIG. 2 is a flow diagram illustrating one embodiment of a method 200 for guiding a user in the construction of an assessment task specification, according to the present invention. The method 200 may be implemented in, for example, a web-based design system that interacts with a user via a graphical user interface. Specific structures such as design patterns, templates, and task specifications that are employed by the method 200 are described in greater detail with respect to FIGS. 3A-7.

The method 200 is initialized at step 202 and proceeds to step 204, where the method 200 presents one or more design patterns, student models, task model variables, rubrics, wizards and/or educational standards to the user. As described in greater detail below, design patterns, student models, task model variables, rubrics, wizards and educational standards are “entry points” into the present invention's system for guiding users in the design of assessments.

In step 206, the method 200 receives one or more design pattern, student model, task model variable, rubric, wizard and/or educational standard selections from the user, which, upon selection, are referred to as the “generating objects”. The selected generating object(s) relates to the substance or goals of the assessment that the user is attempting to design. In one embodiment, the selection of generating object(s) is accompanied by user-modifications to the (existing) selected generating object(s). A user can also use an existing generating object without modification, use a combination of multiple generating objects, or can create a completely new generating object.

Once the generating object(s) have been selected, the method 200 proceeds to step 208 and creates at least one corresponding task template in accordance with the selected generating object(s). As described in greater detail below, the task template presents elements of the assessment design in a detailed manner (e.g., including the character and interactions of the elements), and allows a user to enter variables for customization of the assessment design. The implementation of the selected generating object(s) in step 208 supplies some of these elements in the task template (such as student, task and evidence models). As described in greater detail with respect to subsequent Figures, the creation of the task template also implies the creation of one or more “ancillary objects”, which are objects that are related to the task template and are necessary to save or convey relevant data.

In step 210, the method 200 receives these user-defined variables for incorporation into the task template. The task template is then finalized in step 212 as a task specification in accordance with these user defined variables. The task specification represents a finalized, concrete form of the original task template and may subsequently be used to instantiate assessment tasks. The method 200 then terminates in step 214.

The method 200 thereby guides a user in the design of an assessment task specification for use in an educational assessment. As will be described in greater detail below, the various structures employed by the method 200 (e.g., the design patterns, task templates and associated features) embody knowledge across a variety of domains related to the field of assessment and assessment design. Thus, it is not necessary that a user possess all of this knowledge—the method 200 is capable of guiding even a novice user by presenting the appropriate structures to the user for definition of specific variables related to the assessment.

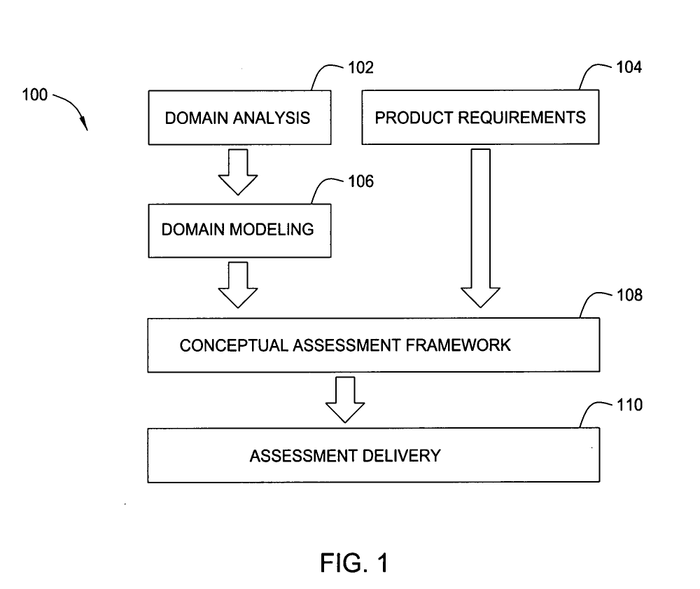

As discussed above, one embodiment of the present invention's process originates with the design pattern. Design patterns lay out a chain of reasoning and serve as a bridge for translating educational goals into a task specification for use in an assessment by specifying elements of an assessment argument. Specifically, the focus of a design pattern is on the substance of an assessment argument, as opposed to the technical details of operational elements and delivery systems (although a design pattern does lay the groundwork for these things). As such, design patterns have particular utility in the domain modeling phase of assessment design (e.g., phase 106 of FIG. 1).

FIGS. 3A-3C comprise a graphical (tabular) representation of an exemplary design pattern 300 according to the present invention. Specifically, the exemplary design pattern 300 is configured for “designing and conducting a scientific investigation”, as indicated by the design pattern's title 304₁. As illustrated, in one embodiment, design patterns such as the design pattern 300 are created in matrix form comprising a plurality of cells for population with specific information (e.g., in the form of text or links to other objects). The design pattern 300 may be a pre-existing design pattern, or may be dynamically created by a user to suit a particular purpose.

The design pattern 300 comprises a plurality of internal attributes 304₁-304ₙ (hereinafter collectively referred to as “attributes 304”), each of which is associated with a value 306 that further defines the attribute 304. Attributes 304 guide the planning of key elements of design models that are created in the conceptual assessment framework phase, as described in greater detail below. In addition, comments 308 that provide additional information may optionally be associated with an attribute 304. In one embodiment, a typical design pattern defines at least three attributes 304: information about the primary or focal knowledge, skills and abilities (KSAs) 304₄ to be assessed (e.g., in the exemplary case, the ability to carry out scientific investigations), potential observations 304₆ that can provide evidence of the focal knowledge and skills (e.g., in the exemplary case, self-assessment of where one is in an investigation, quizzes on processes used in the investigation, posing steps of a scientific investigation, etc.), and characteristic features 304₉ of tasks or kinds of situations that are likely to evoke the desired evidence (e.g., motivating questions or problems to be solved). One particular purpose of the design pattern 300 is to implement these attributes 304 in a manner that suggests a variety of possible ways to assess the same focal knowledge, skills and abilities. Although the exemplary design pattern 300 is populated with data relating to the design and conduct of scientific investigations, design patterns in general are neutral with respect to the particular content, purposes and psychological perspective that relate to attributes 304.

In further embodiments, the design pattern 300 comprises a plurality of additional attributes 304, including at least one of: a summary 304₂ describing the design pattern 300 (e.g., “In this design pattern, students are presented with X . . . ”), a rationale 304₃ for the design pattern 300 (e.g., “Cognitive studies of expertise show Y . . . ”), additional or secondary knowledge, skills and abilities to be assessed 304₅ (e.g., metacognitive skills), potential work products 304₇ that can yield evidence of acquired knowledge, skills or abilities (e.g., as described in sub-patterns of the design pattern 300), potential rubrics 304₈ for scoring work products 304₇, variable features 304₁₀ for shifting the difficulty or focus of the design pattern 300 (e.g., holistic vs. discrete tasks, complexity of inquiry activities, extent of substantive knowledge required, etc.), links 304₁₁, to other design patterns of which the design pattern 300 is a special case (e.g., model-based reasoning), links 304₁₂ to other design patterns that are special cases of the design pattern 300, links 301₁₃ to other design patterns of which the design pattern 300 is a component or step, links 304₁₄ to other design patterns that are components or steps of the design pattern 300 (e.g., planning solution strategies, implementing solution strategies, etc.), links 304₁₅ to educational standards (e.g., National Science Education Standards, unifying concepts 304₁₆ associated with the design pattern 300 such as evidence, models and explanations and science as inquiry standards 304₁₇ such as abilities necessary to perform a scientific inquiry), links 304₁₈ to relevant templates that use the design pattern 300 and may be used in later stages of the assessment design process (e.g., the conceptual assessment framework phase 108 of FIG. 1), links 304₁₉ to exemplar assessment tasks that are instances of the design pattern 300 (e.g., “Mystery Powders”), relevant online resources 304₂₀, relevant references 304₂₁ and other relevant miscellaneous associations 304ₙ. In one embodiment, aspects of the present invention are extensible such that any user-defined attributes may be appended to a design pattern in addition to those listed here.

An assessment task instantiating the design pattern 300 might look, for example, for students to generate a plan for the solution of a problem, where the plan is guided by an adequate representation of the problem situation and possible procedures and outcomes; to implement solution strategies that reflect goals and subgoals; to monitor their actions and flexibly adjust their approach based on performance feedback; and to provide coherent explanations based on underlying principles as opposed to descriptions of superficial features or single statements of fact. Such an assessment task could correspond solely to the design pattern 300 or to an assemblage of multiple design patterns including the design pattern 300. For example, a first design pattern relating to the evaluation of scientific data could be linked to a second design pattern that requires students to design their own investigations and collect their own data. As discussed above, design patterns such as the design pattern 300 of FIGS. 3A-C do not include particular content to create tasks and/or families of tasks; however, tasks may be built by instantiating a design pattern in accordance with substantive bases of the particular field of assessment, as described in further detail below.

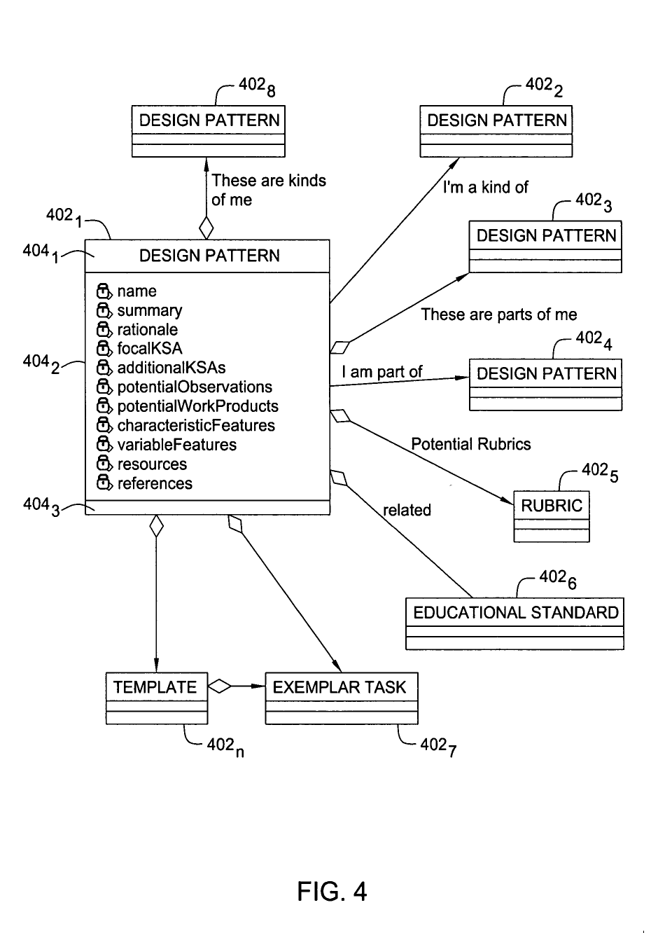

FIG. 4 is an object model 400 (e.g., depicted in accordance with the Unified Modeling Language (UML)) illustrating a generic design pattern 402, and its related objects 402₂-402ₙ (hereinafter collectively referred to as “objects 402”), according to the present invention. Each object 402 is represented by a rectangle comprising three main compartments: a first compartment 404₁ defining the object's title; a second compartment 404₂ defining the object's attributes (e.g., name, summary, rationale, focal knowledge skills and abilities, etc. as discussed in reference to FIGS. 3A-3C)), and a third compartment 404₃ defining the operations that the object 402 can carry out. Those skilled in the art will appreciate that the simplified UML illustration presented in FIG. 4 does not necessarily illustrate every potential attribute or operation; a limited number of exemplary attributes and operations have been illustrated for the sake of simplicity.

As illustrated, the generic design pattern 402₁ may be related to a plurality of other objects 402, including other design patterns 402₂, 402₃, 402₄ and 402₈ (e.g., of which the generic design pattern 402₁ may be a special case or a component, or which may be special cases or components of the generic design pattern 402₁), potential rubrics 402₅ for scoring work products, relevant educational standards 402₆, exemplar tasks 402₇ and relevant task templates 402ₙ.

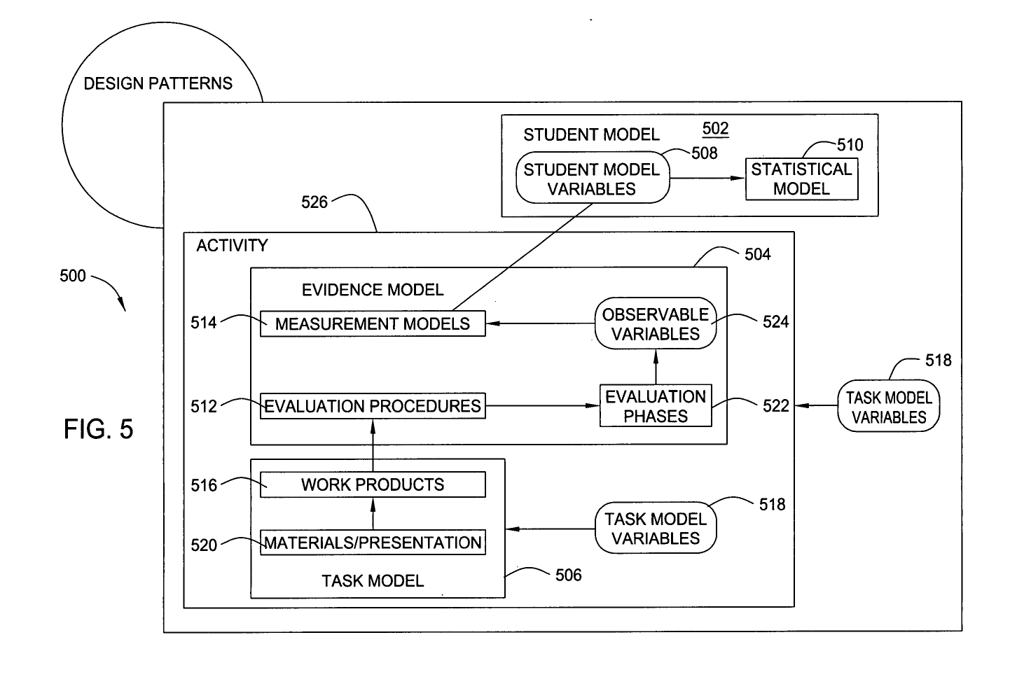

FIG. 5 is a schematic diagram illustrating an exemplary task template 500 according to the present invention. A task template such as the task template 500 provides an abstract design framework for families of related tasks. In one embodiment, task templates are defined at a general level that allows the task templates to be used to describe the elements of assessments of very different kinds (e.g., classroom projects, standardized tests, intelligent tutoring systems, etc.), even though the attributes of the task templates that describe these elements, when implemented, may take radically different forms. Thus, a task template such as the task template 500 may be thought of as a “pre-blueprint” for generating multiple more specific blueprints (referred to as “task specifications”, as described in greater detail below).

That is, when filled in (e.g., with information derived at least in part from the expertise of the assessment designer and/or at least one generating object, such as the design pattern 300 or the other generating objects discussed in conjunction with FIG. 2), a task template such as the task template 500 provides a blueprint or complete set of specifications for creating a family of tasks. As such, task templates have utility in the conceptual assessment framework phase of assessment design (e.g., phase 108 of FIG. 1).

In the embodiment illustrated in FIG. 5, the task template 500 comprises instantiations of at least one student model 502 and at least one activity 526 (further comprising at least one evidence model 504 and at least one task model 506) that represents a phase of the task embodied in the task template 500. Although only one activity 526 is illustrated in FIG. 5, the task template 500 may comprise multiple activities for tasks that require multiple phases or repeated cycles of phases. These models 502, 504 and 506 each address one of the key attributes defined more generally in design patterns (e.g., attributes 304₄, 304₆ and 304₉ in FIG. 3A). Attribute values in generating objects provide or suggest values to be used in associated task template attributes and their contained objects. In further embodiments, the expertise of the assessment designer may suggest additional values that are not present in the generating objects.

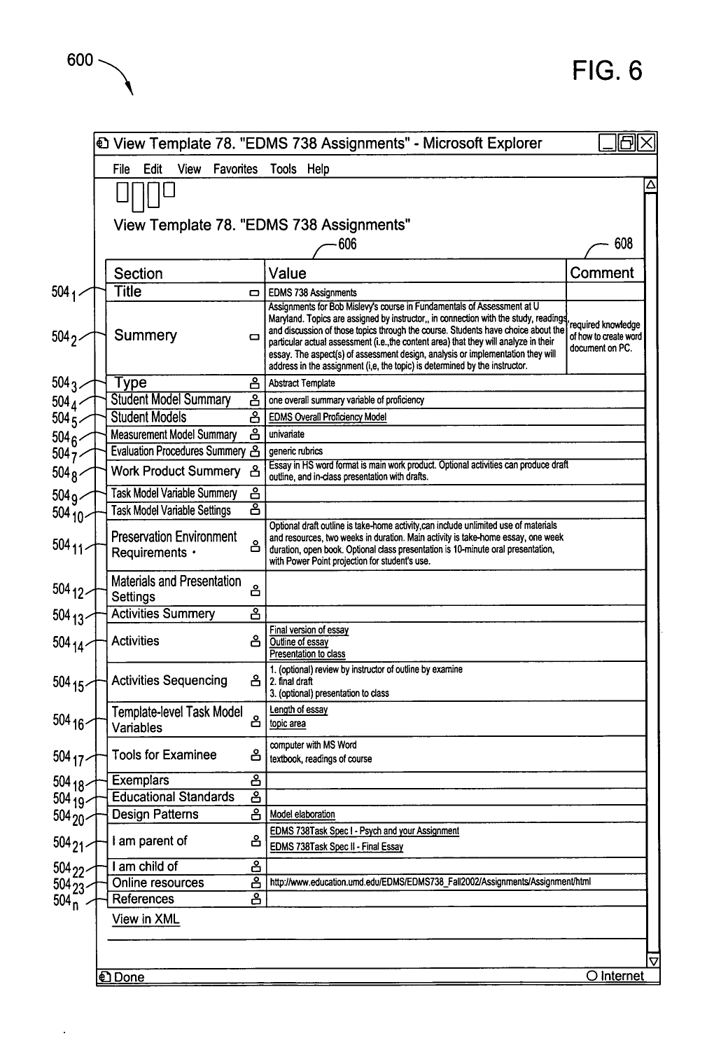

FIG. 6 is a tabular representation of an exemplary task template 600 according to the present invention. Similar to the design pattern 300 illustrated in FIG. 3, the task template 600 is created in matrix form comprising a plurality of cells for population with specific information (e.g., in the form of text or links to other objects). The task template 600 may be a pre-existing task template, or may be dynamically created by a user to suit a particular purpose. For example, the exemplary task template 600 is configured for “EDMS 738 Assignments”, as indicated by the task template's title 604₁. As illustrated, in one embodiment, task templates such as the task template 600 are created in matrix form comprising a plurality of cells for population with specific information (e.g., in the form of text or links to other objects). The task template 600 may be a pre-existing task template, or may be dynamically created by a user to suit a particular purpose.

The task template 600 comprises a plurality of attributes 604₁-604ₙ (hereinafter collectively referred to as “attributes 604”), each of which is associated with a value 606 that further defines the attribute 604. Attributes 604 define the key variables that relate to a specific assessment task to be constructed in accordance with the task template 600. In addition, comments 608 that provide additional information may optionally be associated with an attribute 604.

In one embodiment, the task template 600 defines at least one of the following variables: the title 604₁ (e.g., “EDMS 738 Assignments”), a summary 604₂ describing the task template 600 (e.g., “Assessments for Bob Mislevy's course . . . ”), a task template type 604₃ (e.g., empty or abstract template or template finalized as a task specification), a student model summary 604₄ (e.g., one overall summary variable of proficiency, or multiple variables of proficiency in different areas, as discussed above), one or more links 604₅ to related student models (e.g., “EDMS Overall Proficiency Model), a measurement model summary 604₆ (e.g. univariate), a summary 604₇ of evaluation procedures to be used in accordance with the task template 600 (e.g., generic rubrics), a summary 604₈ of student work products to be produced in accordance with the task template 600 (e.g., essay, in-class presentation, etc.), a summary 604₉ of associated task model variables, one or more task model variable settings 604₁₀, one or more presentation environment requirements 604₁₁, for the student work products (e.g., take-home activity, in class presentation, etc.), one or more materials and/or presentation settings 604₁₂, an activities summary 604₁₃, one or more activities 604₁₄ to be performed in accordance with the student work products (e.g., final version of essay, outline of essay, presentation to class, etc.), a sequence 604₁₅ in which the activities 604₁₄ are to be performed, one or more template-level task model variables 604₁₆ relating to the tasks to be performed in accordance with the task template 600 (e.g., length of essay, topic area, etc.), one or more tools 604₁₇ for use by the examinee/student in performing the tasks associated with the task template 600 (e.g., a computer with a word processing program, a textbook, etc.), one or more exemplars 604₁₈, one or more relevant educational standards 604₁₉, one or more related design patterns 604₂₀ (e.g., a model elaboration design pattern), one or more titles (or other identifying features) of other task templates 604₂₁ of which the task template 600 is a parent (e.g., “EDMS 738 Task Spec I—Psych and Your Assignment)”, “EDMS Task Spec II—Final Essay”, etc.), titles (or other identifying features) of one of more other task templates 604₂₂ of which the task template 600 is a child, one or more links 604₂₃ to relevant online resources (e.g., reading assignments related to a task embodied in the task template 600) and one or more references 604ₙ.

In one embodiment, a task template such as the task template 600 additionally comprises relations to one or more generating objects and ancillary objects, including at least one of: a student model, a student model variable, a task model variable, a materials and presentation setting, an activity, a measurement model, an evaluation procedure, a work product, an observable variable, an exemplar, an educational standard, a design pattern and an additional task template.

Referring back to FIG. 5, student models such as the student model 502 comprise both internal attributes and optional relations to ancillary objects. In one embodiment, the internal attributes of a student model include at least one of: a distribution summary, a distribution type, a covariance matrix, a means matrix, an online resource and a reference. In one embodiment, generating and ancillary objects related to a student model include at least one of: a student model variable (e.g., student model variables 508) and an additional student model.

Specifically, the student model 502 addresses the question of what knowledge, skills or other abilities should be assessed and collects estimates of these student proficiencies. Considerations such as context, use and purpose determine how to move from the narrative level of these knowledge, skills or abilities (defined in the design patterns) to the formal statistical entities that are student model variables 508 and overall student model 502. Each student model variable 508 corresponds to a specific dimension (e.g., type, minimum/maximum values/categories of possible values, etc.) of the overall student model 502. Configurations of values of student model variables 508 approximate selected aspects of the infinite configurations of skills and knowledge that real students have, as seen from some perspective about skills and knowledge in the domain being assessed.

Thus, the nature and number of student models 502 that are derived from the task template 500 express an assumption about the purpose of an assessment that implements the task template 500. For example, in one embodiment, at least one student model 502 is an overall measure of student proficiency (e.g., where all tasks combine to provide evidence of one overall proficiency variable), as might be appropriate to support a simple pass/fail decision.

In another embodiment, at least one student model 502 separates content and inquiry into separate measures of proficiency (e.g., where two student model variables relate to separate and independent skills, such as domain knowledge and inquiry skills), as might be appropriate to support research purposes or classroom teaching and learning. Such a student model 502 assumes that a student may know all of the content necessary to be proficient in a specific domain or subject area, but be unable to apply that content knowledge to inquiry.

In yet another embodiment, at least one student model 502 has a very small grain size (e.g., to assess student proficiency in multiple small subcontent and/or subinquiry areas), as might be appropriate to support a coached practice system designed to help students develop proficiency in the domain under assessment. In this embodiment, separate student model variables 508 are implemented to manage belief about these skills (which are theoretically discernible even though they may be called on jointly to solve problems). Multiple student model variables 508 are necessary when multiple aspects of knowledge are required in combination to support a claim, or where students can possess differing proficiency in that knowledge.

Student model variables (e.g., student model variables 508) that aid in further defining a student model comprise both internal attributes and optional relations to other generating and ancillary objects. In one embodiment, the internal attributes of a student model variable include at least one of: a student model variable type, a minimum student model variable value, a maximum student model variable value, a finite category, an online resource and a reference. In one embodiment, generating and ancillary objects related to a student model variable include at least one of: an educational standard and a continuous zone. Continuous zones further comprise internal attributes including at least one of: a minimum continuous zone value, a maximum continuous zone value and advice to next level.

Given a student model 502 of the appropriate level of detail, a statistical model 510 may be used to manage knowledge about a given student's (unobservable) values for the given student model variables (i.e., estimates of particular facets of student proficiencies) 508 in terms of a probability distribution that can be updated in light of new evidence.

Activities such as the activity 526 comprise both internal attributes and optional relations to other generating and ancillary objects. In one embodiment, the internal attributes of an activity include at least one of: presentation logic, an online resource and a reference. In one embodiment, generating and ancillary objects related to an activity include at least one of: a measurement model (e.g., measurement models 514), an evaluation procedure (e.g., evaluation procedures 512), a work product (e.g., work products 516), a materials and presentations setting (e.g., materials/presentation 520), a task model variable (e.g., task model variables 518) and a design pattern. Further, as discussed above, an activity such as the activity 526 comprises at least one evidence model (e.g., evidence model 504) and at least one task model (e.g., task model 506).

In one embodiment, an evidence model 504 addresses the question of what behaviors or performances should reveal the relevant knowledge and skills described in the student model 502. To this end, an evidence model 504 details how observations for a given task situation constitute evidence about student model variables 508. In one embodiment, an evidence model 504 comprises two main components: (1) evaluation procedures 512 for evaluating the key features of what a student says, does or creates in the task situation (e.g., the work product); and (2) a measurement model 514 reflecting the ways that the evaluation procedures depend, in probability, on student model variables 508. This is how evidence is combined across tasks.

The evaluation procedures 512 contain a sequence of evaluation phases 522 that channel relevant work products (e.g., input from the task model 506 as described in greater detail below) through a series of steps that assess the salient qualities of the work products in the form of scores or observable variables 524. In one embodiment, evaluation procedures such as the evaluation procedures 512 comprise both internal attributes and optional relations to other generating and ancillary objects. In one embodiment, the internal attributes of an evaluation procedure include at least one of: a resource and a reference. In one embodiment, generating and ancillary objects related to an evaluation procedure include at least one evaluation phase (e.g., evaluation phase 522).

Evaluation phases such as the evaluation phase 522 further comprise both internal attributes and optional relations to other generating and ancillary objects. In one embodiment, the internal attributes of an evaluation phase include at least one of: evaluation action data, an evaluation action, an online resource and a reference. In one embodiment, the generating and ancillary objects related to an evaluation phase include at least one of: a work product, an observable variable, a task model variable and another evaluation phase.

Observable variables such as the observable variables 524 further comprise internal attributes, including at least one of: a category (possible value), an online resource and a reference.

The measurement model 514 serves as a bridge to the student model 502 in terms of a psychometric or statistical model for values of an observable variable 524, given values of an associated “parent” student model variable 508. In one embodiment, the measurement model 514 is a special case of the multidimensional random coefficients multinomial logit model (MRCMLM). Furthermore, the measurement model 514 may provide information about several student model variables 508, depending on the relevance of the knowledge or skill being assessed to the overall student model 502.

A measurement model such as the measurement model 514 comprises both internal attributes and optional relations to other generating and ancillary objects. In one embodiment, the internal attributes of a measurement model include at least one of: a measurement model type, a scoring matrix, a design matrix, calibration parameters, an online resource and a reference. In one embodiment, generating and ancillary objects related to a measurement model include at least one of: an observable variable and a student model variable.

In one embodiment, a task model 506 addresses the question of what tasks or situations should elicit the behaviors or performances that reveal the knowledge and skills the assessment is targeting. To this end, a task model 506 is a blueprint for constructing and describing tasks, or the situations in which students act. A task model 506 comprises specifications for the task environment, including, for example, characteristics 520 of stimulus material and presentation, instructions, assignment descriptions, help and tools (e.g., features of the environment in which students will produce evidence for the assessment), as well as specifications 516 for student work product (e.g., marked responses, essays, etc., which are input to the evaluation procedures 512 laid out in the evidence model 504). This design work is guided at least in part by the prior selection or creation of generating objects (which describe the features of the task environment in less detail than the task model 506).

Task model variables 518 describe key features of the stimulus materials 520, relationships among the stimulus materials 520, relationships between a task and characteristics of a student's background (e.g., familiarity with the task's subject area) or other aspects of the task environment. Some task model variables 518 will concern the entire task template 500 (e.g., content area, type of assessment, etc.), while other task model variables concern particular stimulus materials or local attributes within the task template 500 (e.g., the length or topic of an essay to be produced by a student). To this end, task model variables 518 identify particular dimensions along which tasks can vary, and indicate either ranges of variation or particular values along those dimensions.

Task model variables 518 are specified in the construction of the task template 500, but the actual values of the task model variables 518 may be selected during the construction of the task template 500, or in subsequent phases of task specification or task implementation and delivery. Once the task model variables 518 are set, they are available to all related models 502, 504 or 506 within the task template 500.

Task model variable such as the task model variables 518 further comprise both internal attributes and optional relations to other generating and ancillary objects. In one embodiment, the internal attributes of a task model variable include at least one of: a task model variable type, a task model variable category (possible value), an online resource and a reference. In one embodiment, generating and ancillary objects related to a task model variable include at least one other task model variable.

Work products such as work products 516 further comprise internal attributes, including at least one of: a work product type, an example, an online resource and a reference.

Materials and presentation such as materials/presentation 520 further comprise both internal attributes and optional relations to other generating and ancillary objects. In one embodiment, the internal attributes of a material and presentation include at least one of: a material type (e.g., MIME type), a role of at least one related stimulus, an online resource and a reference. In one embodiment, generating and ancillary objects related to a material and presentation include at least one task model variable.

Each task embodied in a task model 506 represents a formalized notion of features of performance situations (e.g., key instances of which are discussed at a more general level in design patterns). For a particular task, the values of task model variables 518 (e.g., high, moderate or low data presentation difficulty, etc.) are data for the argument of proficiency.

In one embodiment, the design of the student model 502, evidence model 504 and task model 506 is an iterative bootstrapping process that begins with a set of learning outcomes to be included in the student model 502. However, as a designer becomes more involved in the creation of tasks that provide context for eliciting those learning outcomes (and later as the designer field tests the assessment with students), new insights are often developed into the natures and limitations of the created tasks. These insights may suggest modifications to at least one of the student model 502, the evidence model 504 and the task model 506.

These various models 502, 504 and 506 and features of the task template 500 are summarized in tabular form in a manner similar to the representation of the design object 300 in FIGS. 3A-C. Alternatively, any of the design patterns 300, task templates 500 and models 502, 504 and 506 may be represented in other formats such as a tree format, flat format, extensible markup language (XML) format or graphical format. Whatever the format, a representation of the task template 500 may include a plurality of attributes such as a title and a summary of the task template 500 and/or the activities 526 and task, evidence and student models 502, 504 and 506 contained therein.

In one embodiment, task templates such as the task template 500, as well as one or more generating and ancillary objects, are extensible such that a designer may access the task template object models to customize or add to the collection of objects, or to include objects and/or private extensions of objects for his or her own assessment design applications. In this way, the present invention supports as wide a variety as possible of assessment tasks, while maintaining the same general argument structure and forms for expressing constituent elements. Moreover, extensibility also allows the present invention to accommodate tests and processes that may not yet exist, but may be developed at a future time.

The task template 500 may be modified as necessary to suit specific assessment needs, e.g., by changing the information within the task template to change the focus of the assessment. For example, within the same general assessment task, the difficulty of the data presentation can be low, moderate or high, thereby affecting the overall difficulty of the assessment task. Thus, while some embodiments of a task template (e.g., task template 500) have a substantially fixed structure, assessment tasks are still afforded a great deal of flexibility. Implemented tasks are instantiations of objects described in general in a task template and described with more particularity in task specifications.

Once every variable 508, 524 and 518 in the task template 500 is set, the task template 500 ceases to become an abstract blueprint and becomes instead a concrete task specification for implementation in an assessment (e.g., to generate assessment tasks).

It will be apparent to those skilled in the art that in addition to enabling users with or without any particular assessment design background to design assessments, a number of other advantages can be realized by the present invention. For example, the present invention accommodates the construction of complex assessments. Where a standard assessment may be described as an assessment in which tasks are discrete, responses are conditionally independent, and the goal is assessment of an overall proficiency in a domain, complex assessments are characterized by one or more of the following features: interactive task settings, multiple task activities, conditionally dependent responses, multivariate models to characterize student proficiencies, and structured relationships between scores or observable variables and student proficiencies. Thus, more detailed and more meaningful assessments can be designed in accordance with the present invention.

Moreover, the present invention is characterized by a great deal of flexibility in that it enables the development of special case uses for any particular style, content or purpose that may be narrower than a given assessment. User interfaces may be adapted so that a user need only interact with the parts of the assessment structure that are relevant to the particular purposes, and these modification will carry through to related structures. This is a particularly significant advantage for users who are novices yet wish to design a meaningful assessment.

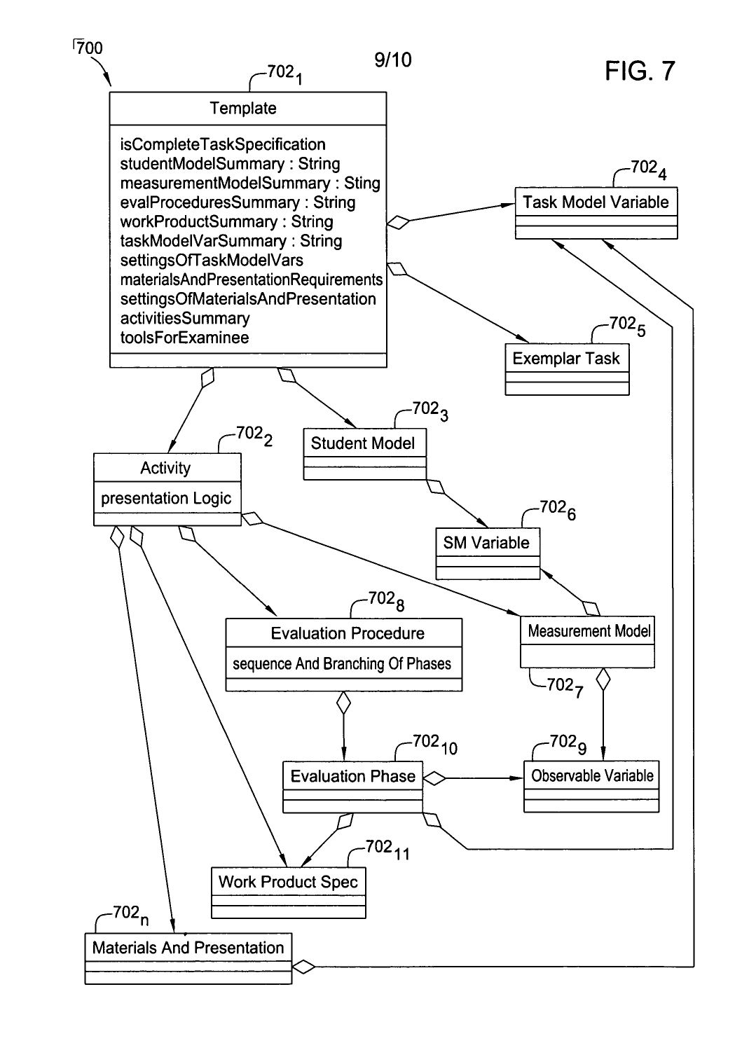

FIG. 7 is an object model 700 (e.g., depicted in accordance with the UML) illustrating a generic task template 702, and its related objects 702₂-702ₙ (hereinafter collectively referred to as “objects 702”), according to the present invention. Similar to the object model 400 illustrated in FIG. 4, each object 702 is represented by a rectangle comprising three main compartments: a first compartment 704, defining the object's title; a second compartment 704₂ defining the object's attributes (e.g., type, student model summary, measurement model summary, etc. as discussed in reference to FIG. 6), and a third compartment 704₃ defining the operations that the object 702 can carry out.

As illustrated, the generic task template 702₁ may be related to a plurality of other objects 702, including related activities 702₂, related student models 702₃, related task model variables 702₄, related exemplar tasks 702₅, related student model variables 702₆, related measurement models 702₇, related evaluation procedures 702₈, related observable variables 702₉, related evaluation phases 702₁₀, specifications 702₁₁ for related work products and related materials and presentations 702ₙ. Those skilled in the art will appreciate that the simplified UML illustration presented in FIG. 7 does not necessarily illustrate every potential attribute or operation.

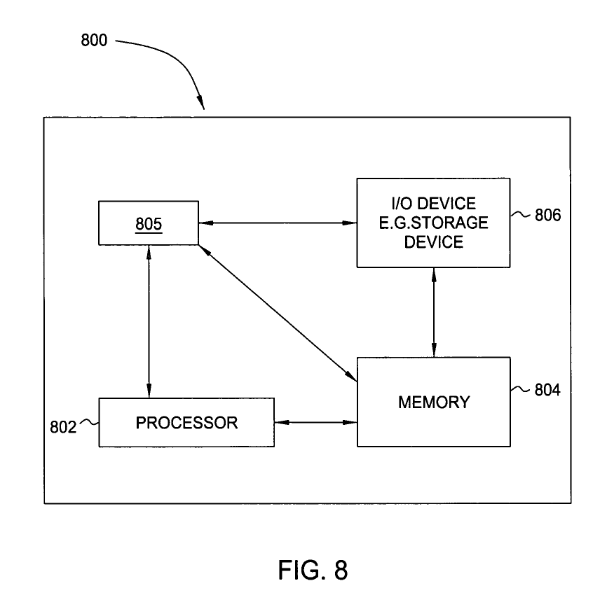

FIG. 8 is a high level block diagram of the present method for guiding a user in the construction of an assessment task design that is implemented using a general purpose computing device 800. In one embodiment, a general purpose computing device 800 comprises a processor 802, a memory 804, an assessment guidance module 805 and various input/output (I/O) devices 806 such as a display, a keyboard, a mouse, a modem, and the like. In one embodiment, at least one I/O device is a storage device (e.g., a disk drive, an optical disk drive, a floppy disk drive). It should be understood that the assessment guidance module 805 can be implemented as a physical device or subsystem that is coupled to a processor through a communication channel.

Alternatively, assessment guidance module 805 can be represented by one or more software applications (or even a combination of software and hardware, e.g., using Application Specific Integrated Circuits (ASIC)), where the software is loaded from a storage medium (e.g., I/O devices 606) and operated by the processor 802 in the memory 804 of the general purpose computing device 800. Thus, in one embodiment, the assessment guidance module 805 for guiding assessment design described herein with reference to the preceding Figures can be stored on a computer readable medium or carrier (e.g., RAM, magnetic or optical drive or diskette, and the like).

Thus, the present invention represents a significant advancement in the field of assessment design. A method and apparatus are provided that are capable of guiding even a novice user in the design of a task specification for an assessment task. The various structures employed by the present invention (e.g., the design patterns, task templates and associated features) embody knowledge across a variety of domains related to the field of assessment and assessment design, making it unnecessary for a user to possess all of this knowledge him or herself.

Although various embodiments which incorporate the teachings of the present invention have been shown and described in detail herein, those skilled in the art can readily devise many other varied embodiments that still incorporate these teachings.

1. A method for guiding a user in the design of an educational assessment task specification, the method comprising:
receiving, from said user, one or more goals relating to the assessment; and
translating said one or more goals into an operational assessment task specification in accordance with one or more user-defined variables.

2. The method of claim 1, wherein said receiving comprises:
receiving, from said user, at least one selected generating object, where said at least one generating object provides a narrative groundwork for said translating.

3. The method of claim 2, wherein said at least one generating object is at least one of: a design pattern, a student model, a task model variable, a rubric, a wizard and an educational standard.

4. The method of claim 3, wherein said at least one generating object is at least one design pattern specifying: at least one aspect of knowledge, skill or ability to be assessed, at least one potential observation for providing evidence of said knowledge, skill or ability and at least one characteristic of a task for evoking said evidence.

5. The method of claim 4, wherein said at least one design pattern further specifies at least one of: a summary of said at least one design pattern, a rationale for said at least one design pattern, at least one additional aspect of knowledge, skill or ability to be assessed, at least one work product for yielding said evidence, at least one rubric for scoring said at least one work product, at least one variable feature for shifting a focus or difficulty level of said at least one design pattern, at least one link to another design pattern, at least one link to an educational standard, at least one unifying concept relating to said at least one design pattern, at least one link to a task template implementing said at least one design pattern, at least one link to an exemplar assessment task that is an instance of said at least one design pattern and at least one resource relevant to said at least one design pattern.

6. The method of claim 3, wherein said at least one generating object is at least one student model specifying at least one of: a distribution summary, a distribution type, a covariance matrix, a means matrix, an online resource related to said at least one student model and a reference related to said at least one student model.

7. The method of claim 3, wherein said at least one generating object is at least one task model variable specifying at least one of: a task model variable type, a task model variable category, an online resource related to said at least one task model variable and a reference related to said at least one task model variable.

8. The method of claim 3, wherein said at least one generating object is related to at least one ancillary object comprising at least one of: a student model, a student model variable, a task model variable, a measurement model, an evaluation procedure, an evaluation phase, a materials and presentation setting, an activity, an exemplar, an educational standard, a continuous zone, a work product, an observable variable, a design pattern and a task template.

9. The method of claim 8, wherein said at least one ancillary object is at least one task template specifying at least one of: a task template type, a student model summary, a measurement model summary, an evaluation procedure summary, a work product summary, a task model variable summary, a task model variable setting, a materials and presentation requirement, an activity summary, a student tool, an online resource related to said at least on task template and a reference related to said at least one task template.

10. The method of claim 8, wherein said at least one ancillary object is at least one student model variable specifying at least one of: a student model variable type, a minimum student model variable value, a maximum student model variable value, a finite category, an online resource related to said at least one student model variable and a reference related to said at least one student model variable.

11. The method of claim 8, wherein said at least one ancillary object is at least one activity specifying at least one of: presentation logic, an online resource related to said at least one activity and a reference related to said at least one activity.

12. The method of claim 8, wherein said at least one ancillary object is at least one evaluation procedure specifying at least one of: an online resource related to said at least one evaluation procedure and a reference related to said at least one evaluation procedure.

13. The method of claim 8, wherein said at least one ancillary object is at least one evaluation phase specifying at least one of: evaluation action data, an evaluation action, an online resource related to said at least one evaluation phase and a reference related to said at least one evaluation phase.

14. The method of claim 8, wherein said at least one ancillary object is at least one observable variable specifying at least one of: an observable variable category, an online resource related to said at least one observable variable and a reference related to said at least one observable variable.

15. The method of claim 8, wherein said at least one ancillary object is at least one measurement model specifying at least one of: a measurement model type, a scoring matrix, a design matrix, a calibration parameter, an online resource related to said at least one measurement model and a reference related to said at least one measurement model.

16. The method of claim 8, wherein said at least one ancillary object is at least one work product specifying at least one of: a work product type, an example, an online resource related to said at least one work product and a reference related to said at least one work product.

17. The method of claim 8, wherein said at least one ancillary object is at least one materials and presentation setting specifying at least one of: a material type, a role of at least one stimulus related to said at least one materials and presentation, an online resource related to said at least one materials and presentation and a reference related to said at least one materials and presentation.

18. The method of claim 8, wherein at least one of said at least one generating object and said at least one ancillary object is extensible.

19. The method of claim 2, wherein said translating comprises:
instantiating said at least one generating object in a task template.

20. The method of claim 19, wherein said task template comprises:
at least one student model defining at least one aspect of knowledge, skill or ability to be assessed; and
at least one activity representing a phase of a task for providing evidence of said at least one aspect of knowledge, skill or ability.

21. The method of claim 20, wherein said at least one student model is configured for an overall measure of proficiency in said at least one aspect of knowledge, skill or ability.

22. The method of claim 20, wherein said at least one student model is configured for:
a first measure of proficiency related to content associated with said at least one aspect of knowledge, skill or ability; and
a second measure of proficiency related to inquiry associated with said at least one aspect of knowledge, skill or ability.

23. The method of claim 20, wherein said at least one student model is configured for a plurality of measures of proficiency, each of said plurality of measures relating to a different subset of said at least one aspect of knowledge, skill or ability.

24. The method of claim 20, wherein said at least one activity comprises:
at least one evidence model defining at least one behavior for revealing said at least one aspect of knowledge, skill or ability; and
at least one task model defining at least one task for eliciting said at least one behavior.

25. The method of claim 24, wherein said at least one evidence model comprises:
at least one evaluation procedure for evaluating features of said at least one behavior; and
at least one measurement model for relating said features of said at least one behavior to said at least one aspect of knowledge, skill or ability.

26. The method of claim 25, wherein said at least one measurement model is a multidimensional random coefficients multinomial logit model.

27. A computer readable medium containing an executable program for guiding a user in the design of an educational assessment task specification, where the program performs the steps of:
receiving, from said user, one or more goals relating to the assessment; and
translating said one or more goals into an operational assessment task specification in accordance with one or more user-defined variables.

28. The computer readable medium of claim 27, wherein said receiving comprises:
receiving, from said user, at least one selected generating object, where said at least one generating object provides a narrative groundwork for said translating.

29. The computer readable medium of claim 28, wherein said at least one generating object is at least one of: a design pattern, a student model, a task model variable, a rubric, a wizard and an educational standard.

30. The computer readable medium of claim 29, wherein said at least one generating object is at least one design pattern specifying: at least one aspect of knowledge, skill or ability to be assessed, at least one potential observation for providing evidence of said knowledge, skill or ability and at least one characteristic of a task for evoking said evidence.

31. The computer readable medium of claim 30, wherein said at least one design pattern further specifies at least one of: a summary of said at least one design pattern, a rationale for said at least one design pattern, at least one additional aspect of knowledge, skill or ability to be assessed, at least one work product for yielding said evidence, at least one rubric for scoring said at least one work product, at least one variable feature for shifting a focus or difficulty level of said at least one design pattern, at least one link to another design pattern, at least one link to an educational standard, at least one unifying concept relating to said at least one design pattern, at least one link to a task template implementing said at least one design pattern, at least one link to an exemplar assessment task that is an instance of said at least one design pattern and at least one resource relevant to said at least one design pattern.

32. The computer readable medium of claim 29, wherein said at least one generating object is at least one student model specifying at least one of: a distribution summary, a distribution type, a covariance matrix, a means matrix, an online resource related to said at least one student model and a reference related to said at least one student model.

33. The computer readable medium of claim 29, wherein said at least one generating object is at least one task model variable specifying at least one of: a task model variable type, a task model variable category, an online resource related to said at least one task model variable and a reference related to said at least one task model variable.

34. The computer readable medium of claim 29, wherein said at least one generating object is related to at least one ancillary object comprising at least one of: a student model, a student model variable, a task model variable, a measurement model, an evaluation procedure, an evaluation phase, a materials and presentation setting, an activity, an exemplar, an educational standard, a continuous zone, a work product, an observable variable, a design pattern and a task template.

35. The computer readable medium of claim 34, wherein said at least one ancillary object is at least one task template specifying at least one of: a task template type, a student model summary, a measurement model summary, an evaluation procedure summary, a work product summary, a task model variable summary, a task model variable setting, a materials and presentation requirement, an activity summary, a student tool, an online resource related to said at least on task template and a reference related to said at least one task template.

36. The computer readable medium of claim 34, wherein said at least one ancillary object is at least one student model variable specifying at least one of: a student model variable type, a minimum student model variable value, a maximum student model variable value, a finite category, an online resource related to said at least one student model variable and a reference related to said at least one student model variable.

37. The computer readable medium of claim 34, wherein said at least one ancillary object is at least one activity specifying at least one of: presentation logic, an online resource related to said at least one activity and a reference related to said at least one activity.

38. The computer readable medium of claim 34, wherein said at least one ancillary object is at least one evaluation procedure specifying at least one of: an online resource related to said at least one evaluation procedure and a reference related to said at least one evaluation procedure.

39. The computer readable medium of claim 34, wherein said at least one ancillary object is at least one evaluation phase specifying at least one of: evaluation action data, an evaluation action, an online resource related to said at least one evaluation phase and a reference related to said at least one evaluation phase.

40. The computer readable medium of claim 34, wherein said at least one ancillary object is at least one observable variable specifying at least one of: an observable variable category, an online resource related to said at least one observable variable and a reference related to said at least one observable variable.

41. The computer readable medium of claim 34, wherein said at least one ancillary object is at least one measurement model specifying at least one of: a measurement model type, a scoring matrix, a design matrix, a calibration parameter, an online resource related to said at least one measurement model and a reference related to said at least one measurement model.

42. The computer readable medium of claim 34, wherein said at least one ancillary object is at least one work product specifying at least one of: a work product type, an example, an online resource related to said at least one work product and a reference related to said at least one work product.

43. The computer readable medium of claim 34, wherein said at least one ancillary object is at least one materials and presentation setting specifying at least one of: a material type, a role of at least one stimulus related to said at least one materials and presentation, an online resource related to said at least one materials and presentation and a reference related to said at least one materials and presentation.

44. The computer readable medium of claim 34, wherein at least one of said at least one generating object and said at least one ancillary object is extensible.

45. The computer readable medium of claim 28, wherein said translating comprises:
instantiating said at least one generating object in a task template.

46. The computer readable medium of claim 45, wherein said task template comprises:
at least one student model defining at least one aspect of knowledge, skill or ability to be assessed; and
at least one activity representing a phase of a task for providing evidence of said at least one aspect of knowledge, skill or ability.

47. The computer readable medium of claim 46, wherein said at least one student model is configured for an overall measure of proficiency in said at least one aspect of knowledge, skill or ability.

48. The computer readable medium of claim 46, wherein said at least one student model is configured for:
a first measure of proficiency related to content associated with said at least one aspect of knowledge, skill or ability; and
a second measure of proficiency related to inquiry associated with said at least one aspect of knowledge, skill or ability.

49. The computer readable medium of claim 46, wherein said at least one student model is configured for a plurality of measures of proficiency, each of said plurality of measures relating to a different subset of said at least one aspect of knowledge, skill or ability.

50. The computer readable medium of claim 46, wherein said at least one activity comprises:
at least one evidence model defining at least one behavior for revealing said at least one aspect of knowledge, skill or ability; and
at least one task model defining at least one task for eliciting said at least one behavior.

51. The computer readable medium of claim 50, wherein said at least one evidence model comprises:
at least one evaluation procedure for evaluating features of said at least one behavior; and
at least one measurement model for relating said features of said at least one behavior to said at least one aspect of knowledge, skill or ability.

52. The computer readable medium of claim 51, wherein said at least one measurement model is a multidimensional random coefficients multinomial logit model.

53. System for guiding a user in the design of an educational assessment task specification, the system comprising:
means for receiving, from said user, one or more goals relating to the assessment; and
means for translating said one or more goals into an operational assessment task specification in accordance with one or more user-defined variables.
